(19) United States
(12) Patent Application Publication
(10) Pub. No.: US 2026/0179087 A1
(43) Pub. Date: Jun. 25, 2026

(54) EMBEDDED CRYPTOGRAMS FOR MULTI-PURPOSE INTERACTIONS

(71) Applicants: AMEX Canada, Inc., North York (CA); American Express Services Europe Limited, London (GB)

(72) Inventors: Magdalena McGoldrick, East York (CA); Manik Biswas, Burgess Hill (GB)

(21) Appl. No.: 18/987,039

(22) Filed: Dec. 19, 2024

(51) Int. Cl. G06Q 20/38

(52) U.S. Cl. CPC G06Q 20/3821; G06Q 20/3829; G06Q 20/3825; G06Q 2220/00

(57) ABSTRACT

Disclosed are various embodiments for providing embedded cryptograms for multi-purpose interactions. A computer system can receive a plurality of requests, where each request has a corresponding identifier. The computer system can generate a sub-cryptogram for each request, where each sub-cryptogram is associated with the respective identifier for the corresponding request. The system can further generate a primary cryptogram based at least in part on each of the sub-cryptograms, where the primary cryptogram represents each of the sub-cryptograms. The system can send the primary cryptogram in response to receipt of the plurality of requests.

### BACKGROUND

In the context of contactless interactions, a cryptogram is an interaction-specific unit of data which has been encrypted with a key. For example, cryptograms can be used to secure transaction data sent between a payment instrument and a payment terminal. A cryptogram can also be used to validate payment information, verify identity, or provide other interaction information. Since a cryptogram is interaction-specific, current systems require one cryptogram per one interaction.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting one of several embodiments of the present disclosure.

FIG. 2 is a drawing of a network environment according to various embodiments of the present disclosure.

FIG. 3 is a flowchart illustrating one example of functionality implemented as portions of an application executed in a computing environment in the network environment of FIG. 2 according to various embodiments of the present disclosure.

FIG. 4 is a sequence diagram illustrating one example of interactions between components of the network environment of FIG. 2 according to various embodiments of the present disclosure.

### DETAILED DESCRIPTION

Disclosed are various approaches for providing embedded cryptograms for multi-purpose interactions. When a user wishes to engage in a multi-purpose interaction, current systems require a unique cryptogram for each purpose in order to secure the information being exchanged and to verify the parties and claims involved. Thus, if a user wishes to provide a digital identity as well as a payment method to complete a transaction, the user may be required to complete a first interaction for identity verification and a second interaction for payment. Since each interaction requires a unique cryptogram, the user must engage in multiple interactions to complete their overall goal. Similarly, if a user wishes to use a service aggregator to pay for several different services (e.g., a travel agency to book a flight, a hotel, and a rental car), either the user or the service aggregator will need to provide each service provider with a unique cryptogram to pay for the service.

In order to maintain the integrity and security of an interaction while using existing channels, a single cryptogram is needed for each interaction. However, it can be a cumbersome process for the user in having to engage in multiple interactions to accomplish one common goal. Similarly, it wastes time and resources in computing power to process multiple separate interactions when there is one common goal. Accordingly, the present disclosure provides methods of embedding multiple sub-cryptograms into a single master cryptogram. The master cryptogram can be submitted in a single interaction. Later, the master cryptogram can be ‘unpacked’ to extract the sub-cryptograms during processing. For example, the user can provide a single master cryptogram, having embedded sub-cryptograms for identity verification and payment information, to a merchant requiring identification for a purchase. The merchant can use the master cryptogram to verify the identity information and the payment information during processing. Thus, by embedding multiple cryptograms into one master cryptogram, computer processing power is greatly reduced for conducting multi-purpose interactions and the process is simplified for the user.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principles disclosed by the following illustrative examples.

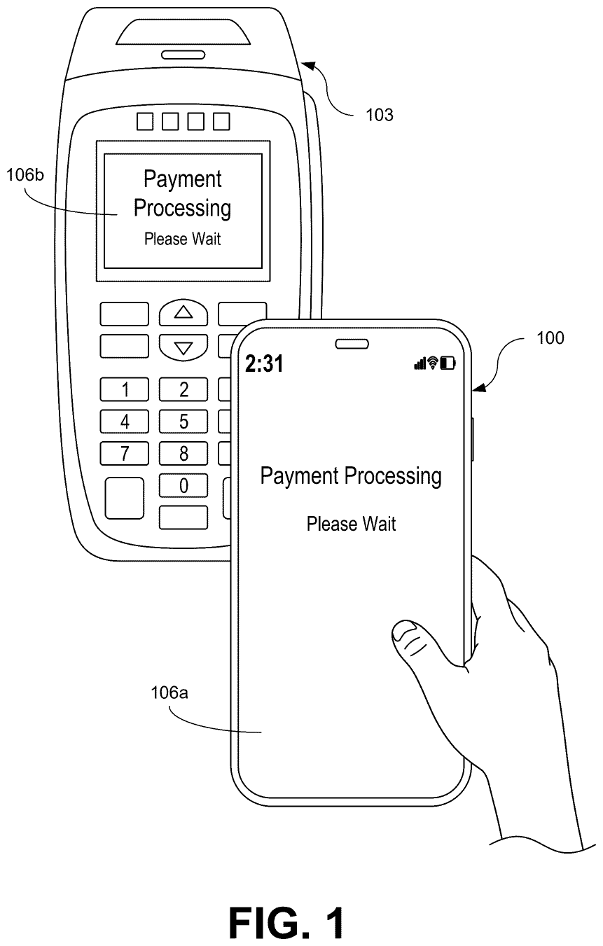

As illustrated in FIG. 1, a client device 100 can interact with a transaction terminal 103 to complete a transaction. While FIG. 1 depicts a client device 100, it is understood that interactions and transactions referred to herein are also capable of including other instruments such as the use of a payment instrument, identity card, or other device enabled to share cryptograms. When a user is at a merchant or vendor's physical location, the user can present their client device 100 to complete an interaction with a transaction terminal 103. In some examples, the client device 100 and the transaction terminal 103 can communicate via a short-range wireless connection in order to complete various tasks. For example, as shown by the user interface 106a of the client device 100 and the user interface 106b of the transaction terminal 103, the client device 100 and the transaction terminal 103 can communicate in order to process a transaction. The short-range wireless connection can be a near-field communication (NFC) connection, a BLUETOOTH® connection, an ultrawideband connection, a WiFi connection, or other form of short-range wireless connection.

Once a connection has been established between the client device 100 and the transaction terminal 103, the transaction terminal 103 can request data from the client device 100 to complete a transaction. In some examples, the transaction terminal 103 may require multiple pieces of data or information from the client device 100 in order to complete multiple transactions. The client device 100 can communicate the requested information to the transaction terminal 103 over the connection. In some examples, the communication can comprise an exchange of encrypted data such as transaction information, payment information, identity information, or other information.

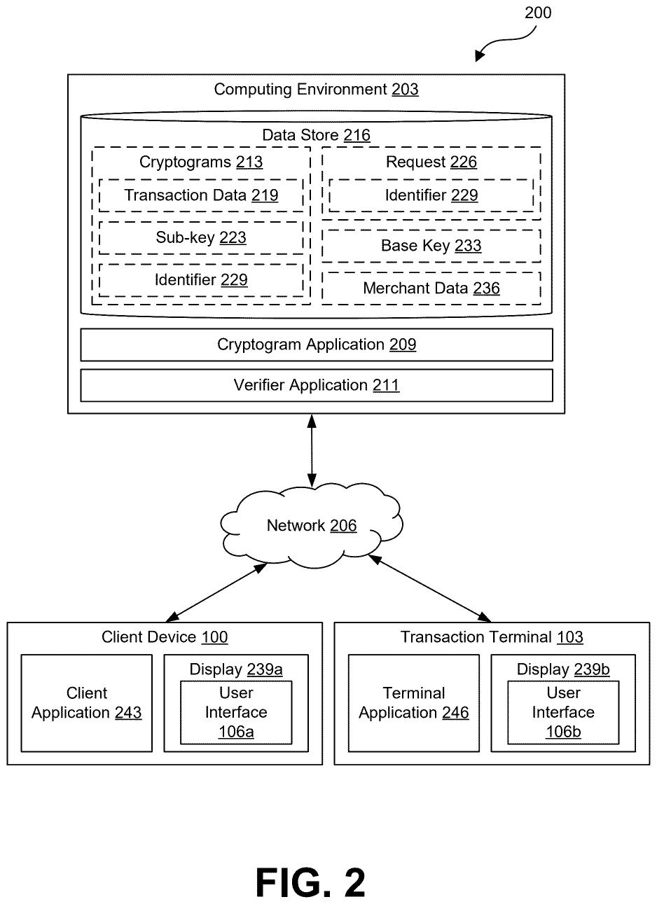

With reference to FIG. 2, shown is a network environment 200 according to various embodiments. The network environment 200 can include a computing environment 203, a client device 100, and a transaction terminal 103, which can be in data communication with each other via a network 206.

The network 206 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (i.e., WI-FI®), BLUETOOTH® networks, microwave transmission networks, as well as other networks relying on radio broadcasts. The network 206 can also include a combination of two or more networks 206. Examples of networks 206 can include the Internet, intranets, extranets, virtual private networks (VPNs), and similar networks.

The computing environment 203 can include one or more computing devices that include a processor, a memory, and/or a network interface. In some examples, the computing environment 203 can comprise one or more computing microchips installed in a payment instrument, identification card, keycard, or other device. The computing devices can be configured to perform computations on behalf of other computing devices or applications. As another example, such computing devices can host and/or provide content to other computing devices in response to requests for content.

Moreover, the computing environment 203 can employ a plurality of computing devices that can be arranged in one or more server banks or computer banks or other arrangements. Such computing devices can be located in a single installation or can be distributed among many different geographical locations. For example, the computing environment 203 can include a plurality of computing devices that together can include a hosted computing resource, a grid computing resource or any other distributed computing arrangement. In some cases, the computing environment 203 can correspond to an elastic computing resource where the allotted capacity of processing, network, storage, or other computing-related resources can vary over time.

Various applications or other functionality can be executed in the computing environment 203. The components executed on the computing environment 203 include a cryptogram application 209, a verifier application 211, and other applications, services, processes, systems, engines, or functionality not discussed in detail herein.

The cryptogram application 209 can be executed to generate cryptograms 213 in response to requests for information. For example, when the cryptogram application 209 receives a request for data, the cryptogram application 209 can identify responsive data corresponding to the request, encrypt the data into a cryptogram 213, and send the cryptogram 213 in response to the request. In some examples, the cryptogram application 209 can generate the cryptograms 213 using a cryptographic key to encode the data or sign the cryptogram. The cryptogram application 209 can be executed in the computing environment 203, on the client device 100, or on a payment instrument, identity card, or other cryptogram-enabled device.

The verifier application 211 can be executed to verify cryptograms 213. After a merchant or vendor has received the cryptograms 213 from the cryptogram application 209, the merchant/vendor can forward the cryptograms 213 to the verifier application 211 to extract the data, verify the data, and complete the transaction. In some examples, the verifier application 211 can be associated with a financial institution associated with the payment instrument which supports the cryptogram application 209. In some examples, the verifier application 211 can be associated with the issuer of an identity instrument which supports the cryptogram application 209. The verifier application 211 can mirror the process completed by the cryptogram application 209 to generate sub-keys for encryption, then use those sub-keys to unencrypt the data in the cryptograms 213.

Also, various data is stored in a data store 216 that is accessible to the computing environment 203. The data store 216 can be representative of a plurality of data stores 216, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 216 is associated with the operation of the various applications or functional entities described below. This data can include cryptograms 213, transaction data 219, sub-keys 223, requests 226 and identifiers 229, base keys 233, merchant data 236, and potentially other data.

The cryptograms 213 can represent encrypted pieces of data which can be generated by the cryptogram application 209 in response to receipt of a request 226. For example, a cryptogram 213 can be used to validate payment information, verify identity, or provide other interaction information. A cryptogram 213 can be a sub-cryptogram 213, or a primary or final cryptogram 213. Sub-cryptograms 213 are cryptograms 213 which are embedded into other cryptograms 213. A primary or final cryptogram 213 can be a cryptogram 213 which includes one or more embedded sub-cryptograms 213. Cryptograms 213 can include encrypted transaction data 219. The transaction data 219 can represent information about a transaction between a user and a merchant or vendor. In some examples, transaction data 219 can include a transaction time, date, amount, merchant identifier, a transaction identifier, payment information, identity information, or other information about a transaction.

A cryptogram 213 can be encrypted with a base key 233 or sub-key 223. The sub-keys 223 are representative of encryption keys which have been derived from the base key 233 and can be used to encrypt and sign the cryptograms 213. In some examples, each cryptogram 213 has a unique sub-key 223. In some examples, the cryptogram 213 can also include an identifier 229.

The requests 226 can represent a message or prompt to send a cryptogram 213. The request 226 can be a request for identity verification, payment information, or other secure information. For example, a request 226 can be sent from a transaction terminal 103 to a cryptogram application 209 to request information to complete a transaction. In some examples, requests 226 are encrypted as cryptograms as well, and are sent over a secure channel to the client device 100, payment instrument, identity instrument, etc. The request 226 can include a unique identifier 229.

The identifiers 229 are representative of a unique sequence of numbers or characters which are specific to a request 226. The identifiers 229 can also include a counter for the requests 226, or otherwise indicate a relative count of the requests 226. For example, if two requests 226 are sent, each request will have a unique identifier 229 which can indicate 1/2, 2/2, etc. to inform the recipient of the number of associated requests 226.

The base key 233 can represent an encryption key from which sub-keys 223 can be derived. In some examples, the base key 233 is an encryption key unique to the client device 100, payment instrument, identity instrument, or other device hosting a cryptogram application 209 for the generation of cryptograms. The base key 233 can be used to encrypt cryptograms 213 directly or to derive sub-keys for encrypting layers of cryptograms 213.

The merchant data 236 can represent various data about the merchant, vendor, or other party associated with the transaction terminal 103. The merchant data 236 can include information about the type of merchant (e.g., retail, service, travel, vendor, etc.), the merchant location, a merchant identifier (e.g., store number, etc.), as well as other information. Merchant data 236 can be transferred from the transaction terminal 103 along with a request 226 during a transaction.

The client device 100 is representative of a plurality of client devices that can be coupled to the network 206. The client device 100 can include a processor-based system such as a computer system. Such a computer system can be embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), media playback devices (e.g., media streaming devices, BluRay® players, digital video disc (DVD) players, set-top boxes, and similar devices), a videogame console, or other devices with like capability. The client device 100 can include one or more displays 239, such as liquid crystal displays (LCDs), gas plasma-based flat panel displays, organic light emitting diode (OLED) displays, electrophoretic ink (“E-ink”) displays, projectors, or other types of display devices. In some instances, the display 239 can be a component of the client device 100 or can be connected to the client device 100 through a wired or wireless connection.

The client device 100 can be configured to execute various applications such as a client application 243 or other applications. The client application 243 can be executed in a client device 100 to access network content served up by the computing environment 203 or other servers, thereby rendering a user interface 106a on the display 239a. To this end, the client application 243 can include a browser, a dedicated application, or other executable, and the user interface 106a can include a network page, an application screen, or other user mechanism for obtaining user input. The client device 100 can be configured to execute applications beyond the client application 243 such as email applications, social networking applications, word processors, spreadsheets, or other applications.

The transaction terminal 103 is representative of a plurality of payment terminals that can be coupled to the network 206. The transaction terminal 103 can include a processor-based system such as a computer system. Such a computer system can be embodied in the form of a designated point-of-sale (POS) machine, a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. The transaction terminal 103 can include one or more displays 239b, such as liquid crystal displays (LCDs), gas plasma-based flat panel displays, organic light emitting diode (OLED) displays, electrophoretic ink (“E-ink”) displays, projectors, or other types of display devices. In some instances, the display 239b can be a component of the transaction terminal 103 or can be connected to the transaction terminal 103 through a wired or wireless connection.

The transaction terminal 103 can be configured to execute various applications such as a terminal application 246 or other applications. The terminal application 246 can be executed in the transaction terminal 103 to access network content served up by the computing environment 203 or other servers, thereby rendering a user interface 106b on the display 239b. The terminal application 246 can be executed to establish a connection with the client application 243 or the cryptogram application 209 to exchange cryptograms 213, requests 226, merchant data 236, transaction data 219, and other information.

Next, a general description of the operation of the various components of the network environment 200 is provided. Although the following description provides one illustrative example of the operations of and interactions between the various components of the network environment 200, other operations and interactions are also encompassed by the various embodiments of the present disclosure. More detailed discussion of the operations of individual components is provided in the discussion accompanying the subsequent drawings.

To begin, a user can engage in an interaction with a merchant or vendor which requires multiple separate pieces of information. The user can present a client device 100, a payment instrument, an identity instrument, or another cryptogram-sharing enabled device to complete the interaction. The device can support a cryptogram application 209 which is capable of establishing a secure short-range connection with a terminal application 246 on a transaction terminal 103 of the merchant. In some examples, the terminal application 246 will send multiple requests 226 for information to the cryptogram application 209. For example, the terminal application 246 can send a request 226 to provide a digital identity as well as a request 226 to provide a payment method to complete a transaction. In another example, the terminal application 246 can send a first request 226 for a first transaction with a first merchant, a second request 226 for a second transaction with a second merchant, etc.

Once the cryptogram application 209 receives the requests 226, the cryptogram application 209 can generate cryptograms 213 corresponding to each of the requests 226. For example, the cryptogram application 209 can generate an identity verification cryptogram 213 in response to a request 226 for identity verification, as well as generate a payment information cryptogram 213 in response to a request 226 for payment information. In some examples, the cryptogram application 209 can layer the cryptograms 213 by generating a first cryptogram 213 from first data, generating a second cryptogram 213 from the first cryptogram 213 and second data, etc., until each request 226 has a corresponding cryptogram 213. However, in other embodiments, the cryptograms 213 can be generated separately, and then combined into a single final cryptogram 213 to be sent to the terminal application 246.

After the cryptogram application 209 has generated the responsive cryptograms 213 and sent a final cryptogram 213 to the terminal application 246, the terminal application 246 can process the cryptogram 213. In some examples, the terminal application 246 forwards the final cryptogram 213 to a verifier application 211. The verifier application 211 can decrypt the cryptogram 213 and sub-cryptograms 213 and process the information in order to complete the transaction.

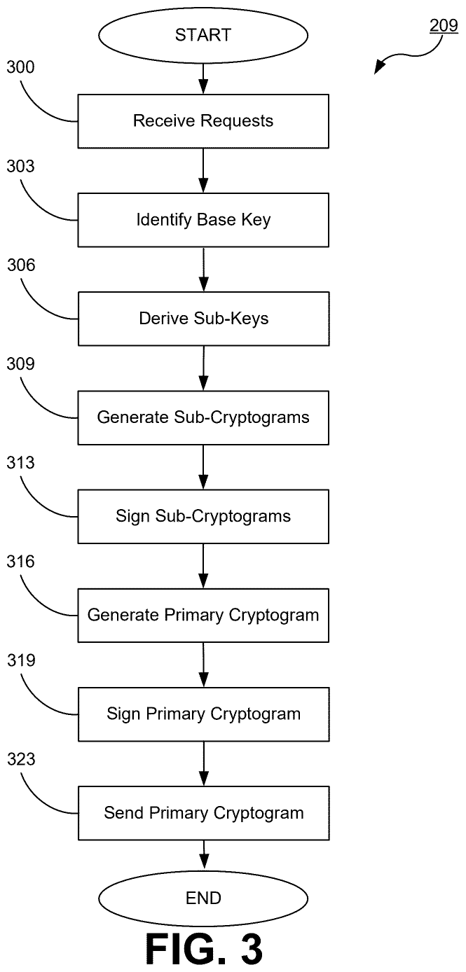

Referring next to FIG. 3, shown is a flowchart that provides one example of the operation of a portion of the cryptogram application 209. The flowchart of FIG. 3 provides merely an example of the many different types of functional arrangements that can be employed to implement the operation of the depicted portion of the cryptogram application 209. As an alternative, the flowchart of FIG. 3 can be viewed as depicting an example of elements of a method implemented within the network environment 200.

Beginning with block 300, the cryptogram application 209 can be executed to receive one or more requests 226. The cryptogram application 209 can receive the requests 226 from a terminal application 246 or other application in the network environment 200. In some examples, the cryptogram application 209 receives the requests 226 over a secure short-range connection which has been established. The cryptogram application 209 can receive the requests 226 in response to the connection being established.

Next, at block 303, the cryptogram application 209 can be executed to identify a base key 233. The base key 233 can be a cryptogram generating key (e.g., an application cryptogram (AC) key) associated with the device hosting the cryptogram application 209. The cryptogram application 209 can identify the base key 233 in response to receiving the requests 226 at block 300. In some examples, the cryptogram application 209 can search a data store 216 on the device hosting the cryptogram application 209 to identify the base key 233.

At block 306, the cryptogram application 209 can be executed to derive one or more sub-keys 223. Using the base key 233 identified at block 303, the cryptogram application 209 can execute an encryption algorithm to generate one or more sub-keys 223 based at least in part on the base key 233. Further, the cryptogram application 209 can derive the sub-keys 223 based at least in part on the request 226 received at block 300 or an identifier 229 of the request 226. In some examples, the cryptogram application 209 can derive one sub-key 223 per request 226 received at block 300.

Next, at block 309, the cryptogram application 209 can be executed to generate one or more sub-cryptograms 213. Once the cryptogram application 209 has derived the sub-keys 223 at block 306, the cryptogram application 209 can generate one or more sub-cryptograms 213 based at least in part on the sub-keys 223. For example, the cryptogram application 209 can generate a sub-cryptogram 213 corresponding to a sub-key 223. In some examples, the cryptogram application 209 generates one sub-cryptogram 213 per sub-key 223 derived at block 306. In some examples, the cryptogram application 209 can generate sub-cryptograms 213 consecutively or concurrently. For example, the cryptogram application 209 can generate a first sub-cryptogram 213, then generate a second sub-cryptogram 213 based on the first sub-cryptogram 213, then generate a third sub-cryptogram 213 based on the second sub-cryptogram 213, etc. Alternatively, the cryptogram application 209 can generate a first, second, etc. sub-cryptogram 213 independently.

At block 313, the cryptogram application 209 can be executed to sign one or more sub-cryptograms 213. The cryptogram application 209 can sign the one or more sub-cryptograms 213 generated at block 309. Each sub-cryptogram 213 can be signed by the corresponding sub-key 223 derived at block 306. Accordingly, one sub-key 223 can be used to sign one sub-cryptogram 213 and another sub-key 223 can be used to sign another sub-cryptogram 213, etc.

At block 316, the cryptogram application 209 can be executed to generate a primary cryptogram 213. As described above, the primary cryptogram 213 can represent a cryptogram 213 which has one or more sub-cryptograms 213 embedded within it. The cryptogram application 209 can generate the primary cryptogram 213 based at least in part on the sub-cryptograms 213 generated at block 309. For example, the primary cryptogram 213 can be generated based at least in part on the final sub-cryptogram 213 from block 309. In another example, the primary cryptogram 213 can be generated to include each of the sub-cryptograms 213 from block 309.

Next, at block 319, the cryptogram application 209 can be executed to sign the primary cryptogram 213. Using a sub-key 223 from block 306, the cryptogram application 209 can sign the primary cryptogram 213 to ensure the primary cryptogram 213 can be authenticated. In some examples, the cryptogram application 209 can sign the primary cryptogram 213 using the base key 233 from block 303.

Next, at block 323, the cryptogram application 209 can send the primary cryptogram 213. The cryptogram application 209 can send the primary cryptogram 213 to a terminal application 246 or other application in the network environment 200. In some examples, the cryptogram application 209 sends the primary cryptogram 213 in response to receipt of the requests 226 from block 300. After block 323, the flowchart of FIG. 3 can come to an end.

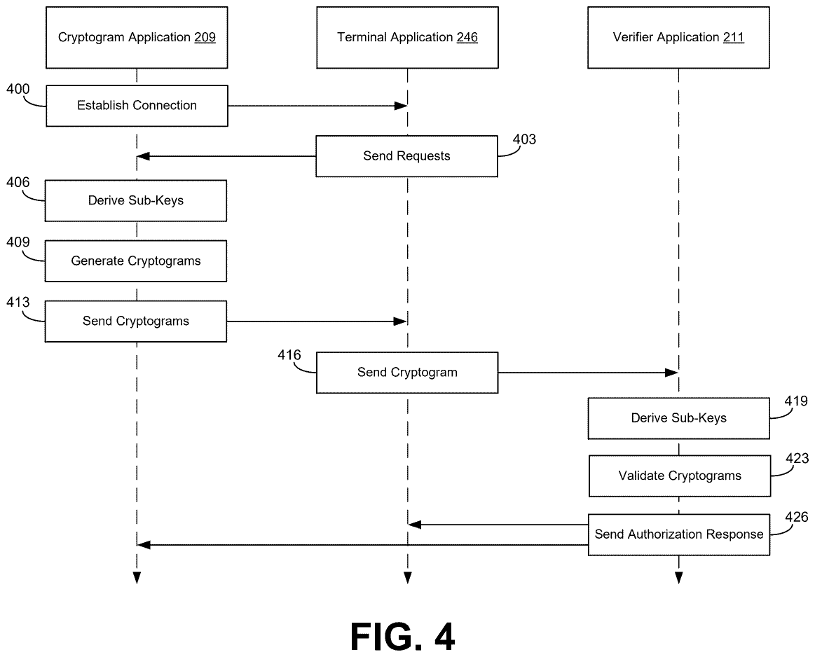

Referring next to FIG. 4, shown is a sequence diagram that provides one example of the operation of the interactions between the cryptogram application 209, the terminal application 246, and the verifier application 211. The sequence diagram of FIG. 4 provides merely an example of the many different types of functional arrangements that can be employed to implement the operations of the depicted portions of the cryptogram application 209, the terminal application 246, and the verifier application 211. As an alternative, the sequence diagram of FIG. 4 can be viewed as depicting an example of elements of a method implemented within the network environment 200.

Beginning with block 400, the cryptogram application 209 can be executed to establish a connection with a terminal application 246 of a transaction terminal 103. In some examples, the cryptogram application 209 and the terminal application 246 can establish a secure short-range wireless connection using near-field communication (NFC) technology supported on the client device 100 and the transaction terminal 103. In other examples, the cryptogram application 209 and the terminal application 246 can establish a secure short-range wireless connection with Bluetooth®, Wi-Fi, ultra-wideband, etc. In some examples, establishing the connection comprises sending and/or receiving signals and verifying that the connection is permissible to both the cryptogram application 209 and the terminal application 246.

Next, at block 403, the terminal application 246 can be executed to send one or more requests 226. In some examples, the requests 226 necessary for a transaction can be determined based at least in part on an input from a user of the transaction terminal 103 hosting the terminal application 246. The terminal application 246 can send the requests 226 to the cryptogram application 209. In some examples, the terminal application 246 can send the requests 226 over the secure short-range connection which has been established at block 400. The terminal application 246 can send the requests 226 in response to the connection being established.

Next, at block 406, the cryptogram application 209 can be executed to derive sub-keys 223. The cryptogram application 209 can derive one or more sub-keys 223 using a base key 233. In some examples, the cryptogram application 209 can execute an encryption algorithm to generate one or more sub-keys 223 based at least in part on the base key 233. The cryptogram application 209 can derive the sub-keys 223 based at least in part on the request 226 received at block 403 or an identifier 229 of the request 226. In some examples, the cryptogram application 209 can derive one sub-key 223 per request 226 received at block 403.

At block 409, the cryptogram application 209 can be executed to generate one or more cryptograms 213. The cryptogram application 209 can use the sub-keys 223 derived at block 406 to generate one or more cryptograms 213. In some examples, the cryptogram application 209 can generate one or more sub-cryptograms 213 as well as a primary cryptogram 213. For example, the cryptogram application 209 can generate a sub-cryptogram 213 corresponding to each sub-key 223 and a primary cryptogram 213 encompassing the sub-cryptograms 213. In some examples, the cryptogram application 209 can generate cryptograms 213 consecutively or concurrently. For example, the cryptogram application 209 can generate a first sub-cryptogram 213, then generate a second sub-cryptogram 213 based on the first sub-cryptogram 213, then generate a primary cryptogram 213 based on the second sub-cryptogram 213, etc. Alternatively, the cryptogram application 209 can generate a first, second, etc. sub-cryptogram 213 independently and a primary cryptogram 213 based at least in part on each of the sub-cryptograms 213.

At block 413, the cryptogram application 209 can be executed to send the cryptograms 213. The cryptogram application 209 can send the cryptograms 213 generated at block 409 to the terminal application 246. The cryptograms 213 can be embedded into a single primary cryptogram 213 which the cryptogram application 209 sends to the terminal application 246. In some examples, the cryptogram application 209 can send the cryptograms 213 in response to having received the requests 226 at block 403.

Next, at block 416, the terminal application 246 can be executed to send the cryptograms 213 to the verifier application 211. The terminal application 246 can receive the cryptograms 213 from the cryptogram application 209 in response to the requests 226 sent at block 403. Based at least in part on the requests 226, the terminal application 246 can determine a verifier corresponding to each request 226 and forward the cryptogram 213 to each verifier. For example, if the terminal application 246 sent a request for proof of identity and payment information, the terminal application 246 could then forward the cryptogram 213 to both the identity verifier (e.g., the issuer of the identity) and the payment information verifier (e.g., the financial institution associated with the payment information).

Moving to block 419, the verifier application 211 can derive one or more sub-keys 223. The verifier application 211 can be configured with the same encryption tools as the cryptogram application 209 and thus, able to derive the sub-keys 223 in the same manner as the cryptogram application 209. For example, the verifier application 211 can identify the base key 233 and derive the sub-keys 223 from the base key 233. In some examples, the verifier application 211 can identify the base key 233 based at least in part on the cryptogram 213. In some examples, the verifier application 211 can derive only the number of sub-keys 223 necessary to reach the sub-cryptogram 213 corresponding to the verifier. For example, if the verifier is an identity verifier and the identity claim was embedded as the first sub-cryptogram 213, the verifier application 211 can determine which sub-cryptogram 213 corresponds to the identity claim based at least in part on an identifier 224 associated with the sub-cryptogram 213. Then, the verifier application 211 can determine how many layers of cryptograms 213 need to be decrypted to reach the identity claim and derive the corresponding number of sub-keys 223.

At block 423, the verifier application 211 can validate the cryptograms 213. Using the sub-keys 223 derived at block 419, the verifier application 211 can decrypt the primary cryptogram 213 to reach the sub-cryptograms 213. In some examples, the verifier application 211 can decrypt a first sub-cryptogram 213 to reach a second sub-cryptogram 213 and decrypt the second sub-cryptogram 213 to reach a third sub-cryptogram. Once the appropriate cryptogram 213 has been reached and decrypted, the verifier application 211 can validate the cryptogram 213 by verifying the information contained in the cryptogram 213. In some examples, the cryptogram 213 is verified by comparing the data within the cryptogram to data in an internal data store 216 of the verifier.

Next, at block 426, the verifier application 211 can be executed to send an authorization response. The verifier application 211 can send one or more authorization responses to the terminal application 246, and in some examples, to the cryptogram application 209. Once the cryptograms 213 have been validated, or not validated, the verifier application 211 can generate an authorization response to notify the parties whether the cryptograms 213 were validated. Then, the verifier application 211 can send this authorization response to the terminal application 246 from which it received the cryptogram 213 at block 416. After block 426, the sequence diagram of FIG. 4 can come to an end.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g., storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment 203.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

1. A system, comprising:
a computing device comprising a processor and a memory; and
machine-readable instructions stored in the memory that, when executed by the processor, cause the computing device to at least:
receive a plurality of requests, each request of the plurality of requests having a corresponding identifier;
generate a sub-cryptogram for each request of the plurality of requests, each sub-cryptogram associated with the respective identifier for a corresponding request;
generate a primary cryptogram based at least in part on each of the sub-cryptograms, wherein the primary cryptogram is encrypted and can be decrypted to reach each of the sub-cryptograms; and
send the primary cryptogram in response to receipt of the plurality of requests.

2. The system of claim 1, wherein the machine-readable instructions further cause the computing device to at least derive a respective sub-key for each request of the plurality of requests based at least in part on a base key, wherein the sub-cryptogram is based at least in part on the respective sub-key.

3. The system of claim 1, wherein the machine-readable instructions further cause the computing device to at least:
generate a first sub-cryptogram corresponding to a first request of the plurality of requests and associated with a first identifier;
generate a second sub-cryptogram corresponding to a second request of the plurality of requests and associated with a second identifier, where the second sub-cryptogram is generated based at least in part on the first sub-cryptogram; and
generate the primary cryptogram based at least in part on the second sub-cryptogram, where the primary cryptogram is associated with the first identifier and the second identifier.

4. The system of claim 1, wherein the machine-readable instructions which cause the computing device to generate the primary cryptogram further cause the computing device to at least, generate the primary cryptogram based at least in part on a first sub-cryptogram and a second sub-cryptogram, the primary cryptogram being associated with a first identifier corresponding to the first sub-cryptogram and a second identifier corresponding to the second sub-cryptogram.

5. The system of claim 1, wherein each sub-cryptogram comprises encoded data responsive to the corresponding request.

6. The system of claim 1, wherein the primary cryptogram comprises encoded data representing each sub-cryptogram.

7. The system of claim 1, wherein the plurality of requests are received from a transaction terminal, and the primary cryptogram is sent to the transaction terminal.

8. A method, comprising:
receiving, by a computing device, a plurality of requests, each request of the plurality of requests having a corresponding identifier;
generating, by the computing device, a sub-cryptogram for each request of the plurality of requests, each sub-cryptogram associated with the respective identifier for a corresponding request;
generating, by the computing device, a primary cryptogram based at least in part on each of the sub-cryptograms, wherein the primary cryptogram is encrypted and can be decrypted to reach each of the sub-cryptograms; and
sending, by the computing device, the primary cryptogram in response to receipt of the plurality of requests.

9. The method of claim 8, further comprising at least deriving, by the computing device, a sub-key for each request of the plurality of requests based at least in part on a base key, wherein the sub-cryptogram is based at least in part on a respective sub-key.

10. The method of claim 8, further comprising at least:
generating, by the computing device, a first sub-cryptogram corresponding to a first request of the plurality of requests and associated with a first identifier;
generating, by the computing device, a second sub-cryptogram corresponding to a second request of the plurality of requests and associated with a second identifier, where the second sub-cryptogram is generated based at least in part on the first sub-cryptogram; and
generating, by the computing device, the primary cryptogram based at least in part on the second sub-cryptogram, where the primary cryptogram is associated with the first identifier and the second identifier.

11. The method of claim 8, wherein generating the primary cryptogram further comprises at least generating, by the computing device, the primary cryptogram based at least in part on a first sub-cryptogram and a second sub-cryptogram, the primary cryptogram being associated with a first identifier corresponding to the first sub-cryptogram and a second identifier corresponding to the second sub-cryptogram.

12. The method of claim 8, wherein each sub-cryptogram comprises encoded data responsive to the corresponding request.

13. The method of claim 8, wherein the primary cryptogram comprises encoded data representing each sub-cryptogram.

14. The method of claim 8, wherein the plurality of requests is received from a transaction terminal, and the primary cryptogram is sent to the transaction terminal.

15. A system, comprising:
a computing device comprising a processor and a memory; and
machine-readable instructions stored in the memory that, when executed by the processor, cause the computing device to at least:
receive a first request having a first identifier and a second request having a second identifier;
generate a first cryptogram comprising first data and the first identifier;
generate a second cryptogram based at least in part on the first cryptogram, the second cryptogram comprising second data and the second identifier;
generate a final cryptogram based at least in part on the second cryptogram, wherein the final cryptogram is encrypted and can be decrypted to reach at least the second cryptogram; and
send the final cryptogram in response to receipt of the first request and the second request.

16. (canceled)

17. The system of claim 15, wherein the final cryptogram further comprises the first cryptogram.

18. The system of claim 15, wherein the machine-readable instructions, when executed by the processor, further cause the computing device to at least:
identify a base cryptogram generation key;
generate a first cryptogram key based at least in part on the base cryptogram generation key; and
sign the first cryptogram using the first cryptogram key.

19. The system of claim 18, wherein the machine-readable instructions, when executed by the processor, further cause the computing device to at least:
generate a second cryptogram key based at least in part on the first cryptogram key; and
sign the second cryptogram using the second cryptogram key.

20. The system of claim 18, wherein the machine-readable instructions, when executed by the processor, further cause the computing device to at least:
generate a final cryptogram key based at least in part on the base cryptogram generation key; and
sign the final cryptogram using the final cryptogram key.

21. The system of claim 18, wherein the base cryptogram generation key is an encryption key unique to the computing device.
